(19) United States
(12) Patent Application Publication
(10) Pub. No.: US 2004/0185715 A1
(43) Pub. Date: Sep. 23, 2004

(54) Electrical connector

(76) Inventors: Takeshi Kimura, Kanagawa-ken (JP); Kazuya Orui, Kawasaki (JP); Kunihiko Shimizu, Kawasaki (JP); Hiroyuki Otaguro, Kawasaki (JP); Rie Takada, Kawasaki (JP)

Correspondence Address: JoAnn Dilloway, Barley, Snyder, 126 East King Street, Lancaster, PA, 17602-2893, US

(21) Appl. No.: 10/804,635

(22) Filed: Mar. 19, 2004

(30) Foreign Application Priority Data
Mar. 20, 2003 (JP) 2003-78301

(51) Int. Cl. H01R 13/648

(52) U.S. Cl. 439/608

(57) ABSTRACT

The present invention is an electrical connector, having multiple terminals equipped with compliant sections to be inserted into through-holes in a main board; multiple sub-boards equipped with lands connected to the terminals and a contact section to be connected to a mating connector. The lands consist of a conductor formed on an insulator and a housing used to secure the multiple sub-boards in an array, wherein owing to a conductor which extends close to the terminal-side edge of the insulator, the lands prevent the sub-boards from being buckled by being bitten by the terminals when the compliant sections are inserted into the through-holes in the main board.

### FIELD OF THE INVENTION

The present invention relates to an electrical connector in which multiple substrates (referred to as sub-boards herein) are secured in an array.

### BACKGROUND OF THE INVENTION

Conventionally, electrical connectors in which multiple sub-boards known as chicklets are secured in an array are used as electrical connectors to electrically connect multiple circuit boards. For example, a circuit board called a motherboard and a circuit board known as a daughter board may be connected in this manner. For example, U.S. Pat. No. 6,171,115 discloses an electrical connector, having multiple terminals inserted into through-holes in a main board; traces connected to the terminals; multiple sub-boards (chicklets) equipped with a contact section to be connected to a mating connector installed on a circuit board; and a housing used to secure the boards in an array.

With the electrical connector according to the conventional technique, the terminals bite into the lower end of the sub-boards (chicklets), buckling the lower end of the sub-boards when the terminals are press-fitted into the through-holes in the main board. Large buckling will displace the terminals, weakening the fit in the through-holes in the main board and thereby lowering the normal contact force at the terminals. Thus, the conventional technique has the problem that the electrical connector may not be mounted properly on the main board. For example, the press-fit parts of the terminals may not be inserted to prescribed depth in the through-holes in the main board, lowering the reliability of connection and causing bad electrical connections.

In view of the above circumstances, the present invention has an object to provide an electrical connector which can be mounted more reliably on a main board.

### SUMMARY OF THE INVENTION

The present invention is an electrical connector, having multiple terminals equipped with compliant sections to be inserted into through-holes in a main board; multiple sub-boards equipped with lands connected to the terminals and a contact section to be connected to a mating connector. The lands consist of a conductor formed on an insulator and a housing used to secure the multiple sub-boards in an array, wherein owing to a conductor which extends close to the terminal-side edge of the insulator, the lands prevent the sub-boards from being buckled by being bitten by the terminals when the compliant sections are inserted into the through-holes in the main board.

### BRIEF DESCRIPTION OF THE DRAWINGS

The invention will now be described by way of example with reference to the accompanying figures of which:

FIG. 1 is a perspective view showing a first connector according to a first embodiment of the present invention and a second connector which mates with the first connector;

FIGS. 2(A)-(E) are a front view, plan view, left side view, right side view, and bottom view, respectively, of the first connector;

FIG. 3 is a sectional view showing the first connector and second connector in mated condition;

FIG. 4 is a side view of a first surface of a sub-board of the first connector;

FIG. 5 is a side view of a second surface of the sub-board;

FIG. 6 is an enlarged view of terminals of the first connector;

FIG. 7 is a sectional view taken along A-A′ line in FIG. 6;

FIG. 8 is a side view of a substrate in a connector according to a second embodiment of the present invention; and

FIG. 9 is an enlarged view of terminals of the connector according to the second embodiment of the present invention.

### DETAILED DESCRIPTION OF THE PREFERRED EMBODIMENTS

Embodiments of the present invention will be described below with reference to the drawings.

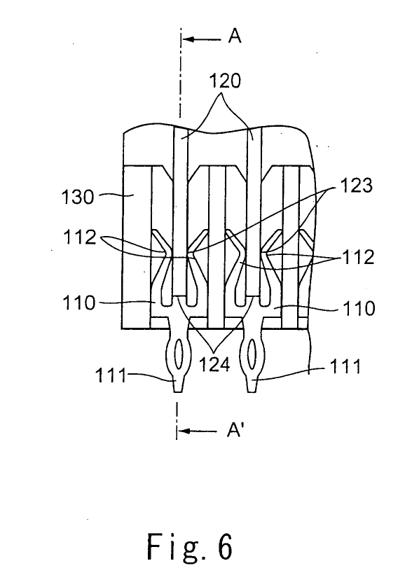

The first connector 100 includes terminals 110 (see, for example, FIG. 6) equipped with compliant sections 111 to be inserted into through-holes in a daughter board (not shown) which corresponds to the main board according to the present invention, multiple sub-boards (chicklets) 120 arranged in an array, and a housing 130 which secures the multiple sub-boards 120 in an array.

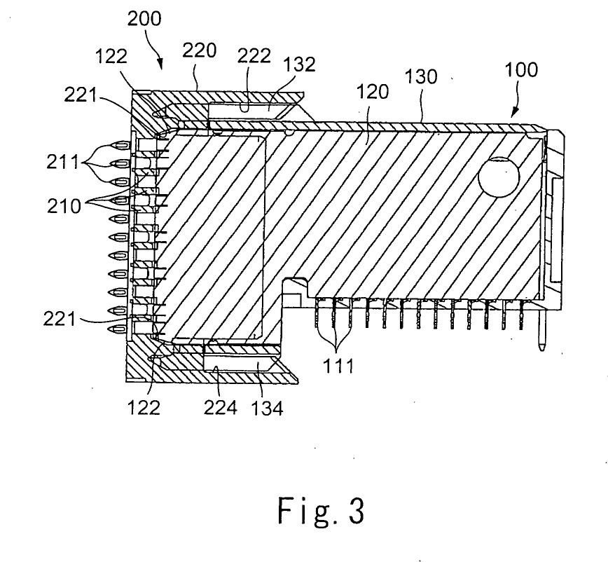

The second connector 200 is provided with compliant sections 211 to be inserted into through-holes in a motherboard to be connected with the daughter board via the first and second connectors 100 and 200. It includes, multiple female terminals 210 (see, for example, FIG. 3) which engage contact sections 121 provided on the sub-boards 120 of the first connector 100 and a housing 220 which secures the multiple female terminals 210 and has an opening to accept the first connector 100.

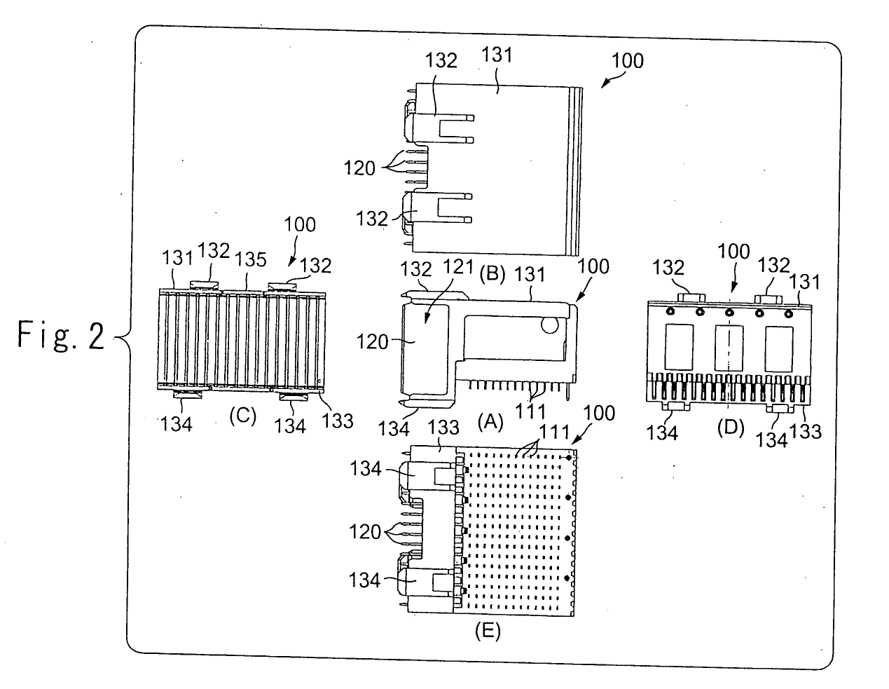

The terminals 110 of the first connector 100 are arranged in a two-dimensional array in large numbers as can be seen from their respective compliant sections 111 shown in FIG. 2(E). Accordingly, a large number of through-holes are formed in the daughter board (not shown) to accept the compliant sections 111.

The sub-boards 120 of the electrical connector 100 are arranged in the vertical direction as shown in FIG. 2(E) and each of them is connected to a corresponding horizontal row of terminals. The connection between the sub-boards 120 and terminals 110 will be described later.

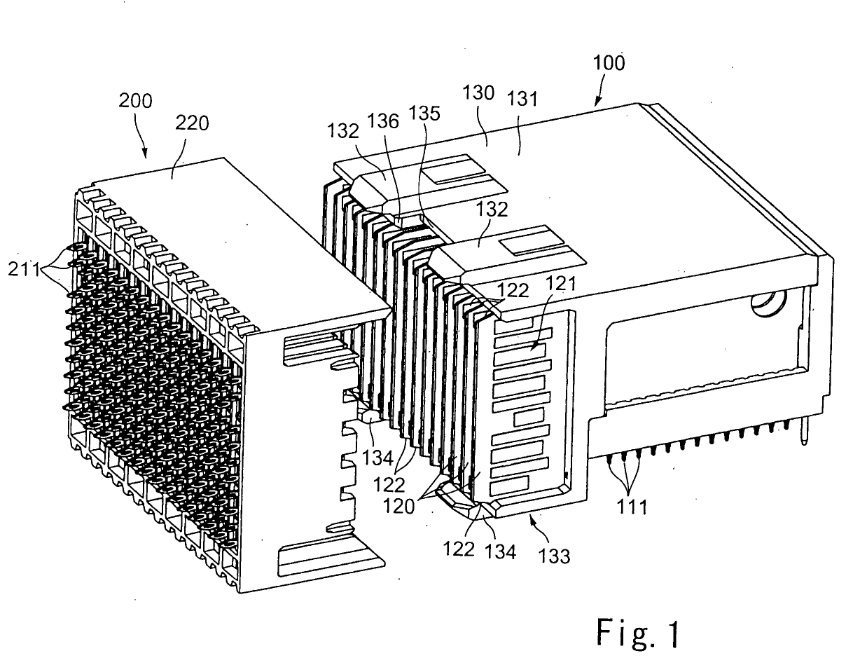

As shown in FIG. 1, the contact section 121 is formed on the mating end of each sub-board 120. On that side on which the contact section 121 is formed, corners of each sub-board 120 have chamfers 122. The chamfers 122 are used for vertical positioning of the sub-boards 120 during mating of the first connector 100 and second connector 200.

Also, in the housing 130 of the first connector 100, first guides 132 are formed on an top wall 131 and second guides 134 are formed on a bottom wall 133.

The first guides 132 are disposed at two locations on the top wall 131 at a certain distance from each other and the second guides 134 are disposed at two locations on the bottom wall 133 separated by a distance different from the distance between the first guides 132 on the top wall 131. As shown in FIG. 3, in the housing 220 of the second connector 200, a pair of first complementary guides 222 and a pair of second complementary guides 224 are disposed at locations which correspond, respectively, to the locations of the pair of first guides 132 and the pair of second guides 134 on the housing 130 of the first connector 100. The first guides 132 and second guides 134 together with the corresponding first complementary guides 222 and second complementary guides 224 constitute a rough guide mechanism which roughly guides the mating between the first connector 100 and second connector 200 at the initial stage of mating.

When the first connector 100 and second connector 200 are mated, the second connector 200 has tapers 221 (see, FIG. 3) which correspond to and receive the chamfers 122. The Chamfers 122 and tapers 221 form a precision guide mechanism which guides the mating between the first connector 100 and second connector 200 more precisely than the rough guide mechanism in an advanced stage of mating.

A recess 135 is formed between the first guides 132 in the housing 130 of the first connector 100. Chamfers 136 are formed in the corners of the recess 135. The second connector 200 has a protrusion (not shown) in the depth between the first complementary guides 222. The protrusion is formed at a location which corresponds to the recess 135 and enters the recess 135 when the first connector 100 and second connector 200 are mated. Corners of the protrusion are tapered corresponding to the chamfers 136 on the entrance corners of the recess 135.

The recess 135 between the first guides 132 of the first connector 100 as well as the corresponding protrusion on the second connector 200 are constituent parts of the precision guide mechanism.

Thus, at the initial stage of mating, the first connector 100 and second connector 200 are mated together by being roughly guided as the first guides 132 and second guides 134 of the first connector 100 enter the first complementary guides 222 and second complementary guides 224 of the second connector 200. The distance between the two first guides 132 (and the corresponding two first complementary guides 222) differs from the distance between the two second guides 134 (and the corresponding two second complementary guides 224) to prevent the connectors from being mated upside down by mistake.

In an advanced stage of mating, a precision guide in the vertical direction is provided by the chamfers 122 of the first connector 100 in conjunction with the corresponding tapers 221 on the housing 220 of the second connector 200 while a horizontal precision guide is provided by the recess 135 formed between the two first guides 132 on the housing 130 of the first connector 100 and the corresponding protrusion (not shown) formed in the housing 220 of the second connector 200. Thus, at the initial stage, mating is started even if the first connector 100 and second connector 200 are positioned more or less imprecisely, and at the advanced stage, precision mating is done with the help of the precision guide mechanism.

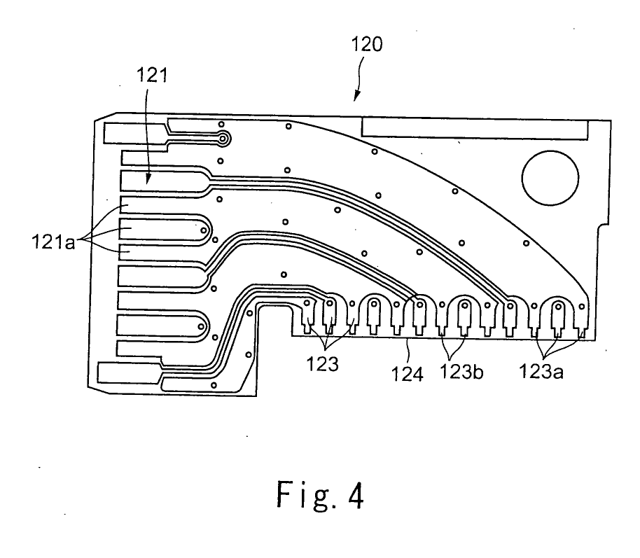

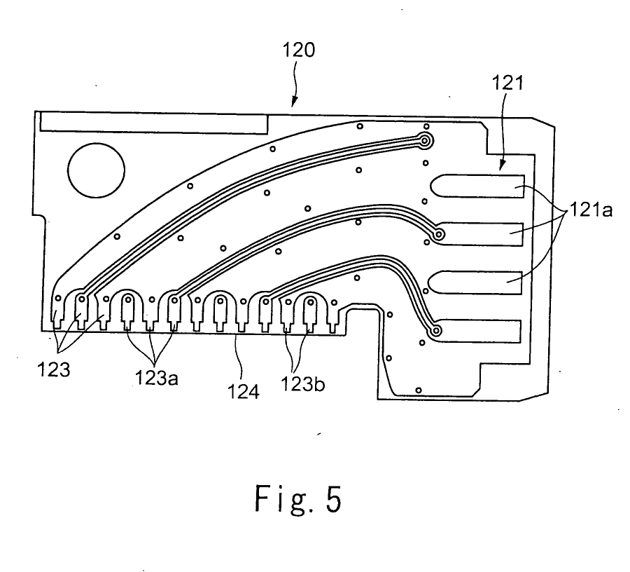

Referring now to FIGS. 4 and 5, the sub-board 120 contains the contact section 121 which is to be inserted in the second connector as well as multiple lands 123 arranged along an edge 124 of the sub-board 120. The lands 123 consist of conductor patterns formed on a plate of an insulator which is the base material of the sub-board 120. Each land 123 is connected to a respective contact pattern 121a arranged on the contact section 121.

Each land 123 extends close to the edge 124 of the sub-board. As shown in FIGS. 4 and 5, only a small area consisting solely of an insulator remains between the edge 124 and a bottom edge 123b of the land 123. The reason why the area consisting solely of an insulator is left on the edge 124 of the sub-board 120 is to eliminate the possibility of peeling off the lands 123 when cutting the substrate from a large wafer. The distance between the edge 124 of the sub-board 120 and the bottom edge 123b of the land 123 may be approximately 0.3 mm. or less.

That part of each land which is close to the edge 124 of the sub-board 120 is narrower than the remainder of the land 123. The lands 123 are connected with the respective terminals 110 (see FIGS. 1 to 3) of the first connector 100 as described later. The reason why that part of each land which is close to the edge 124 of the sub-board 120 is narrower than the other part of the land 123 is to optimize insulation distance between the land 123 and the terminals 110 connected to adjacent lands 123. This will be further described later.

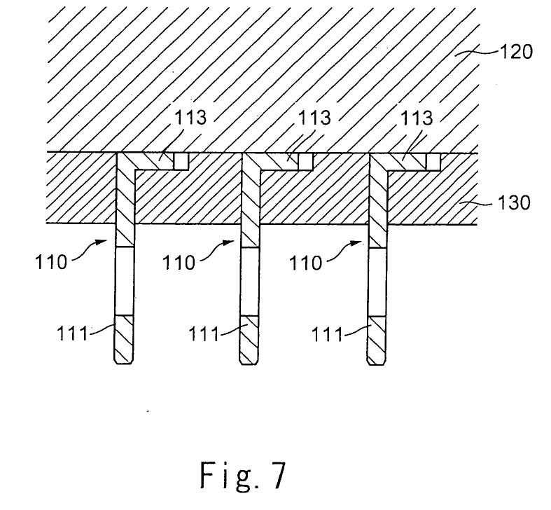

FIGS. 6 and 7 show terminals 110 each of which has a compliant section 111 to be inserted into a through-hole in the main board (not shown). A fork-shaped contact 112 is formed on that part of the terminal 110 which is located inside the first connector housing 130 to receive the land 123 (see FIGS. 4 and 5) of the sub-board 120. Also, a sub-board support 113 (see FIG. 7) is formed on that part of the terminal 110 which contacts the edge 124 of the sub-board 120. It is bent into the paper in FIG. 6 and extends along the edge 124 of the sub-board 120.

The terminals 110 of this shape are arranged in a two dimensional array in the housing as shown in FIG. 2(E). When the first connector 100 is assembled, the lands 123 of the sub-boards 120 are inserted into the contacts 112 of the terminals 110 secured in the housing 130.

The sub-board supports 113 of the terminals 110 support the lower end of the sub-boards 120 when the compliant sections 111 are inserted into the through-holes in the main board. They serve to distribute the pressure placed by the terminals 110 on the sub-boards 120, reducing buckling of the bottom edges 124 of the sub-boards 120, when the terminals are inserted. However, the pressure distribution effect of the sub-board supports 113 alone cannot completely prevent the bottom edges 124 of the sub-boards 120 from buckling. Thus, as described with reference to FIGS. 4 and 5, the lands 123 formed on the sub-boards 120 are extended close to the bottom edges 124 of the sub-boards 120. The lands 123 reinforce the part around the bottom edges 124 of the sub-boards 120, and thereby prevent the bottom edges 124 of the sub-boards 120 from buckling. Consequently, the first connector 100 can be inserted or press-fit into the through-holes in the main board (daughter board) with high reliability.

Each sub-board support 113 of the terminal 110 extends to near the adjacent land 123 along the bottom edge 124 of the sub-board 120 as shown in FIG. 7. If the tip of the sub-board support 113 is too close to the lower end of the adjacent land 123, it may become difficult to ensure insulation distance, resulting in a lowered threshold voltage. To avoid this situation, that part of the land 123 which is close to the bottom edge 124 of the sub-board 120 is narrowed to keep clear of the sub-board support 113 of the terminal 110.

Next, a second embodiment of the present invention will be described. Regarding the second embodiment, description will be given of only those parts which are different from the first embodiment described above.

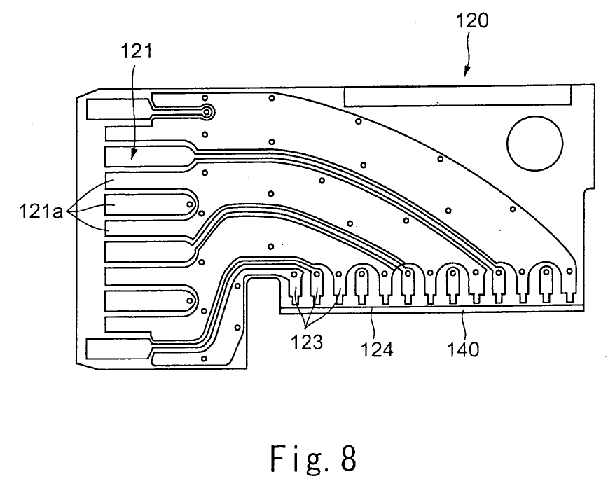

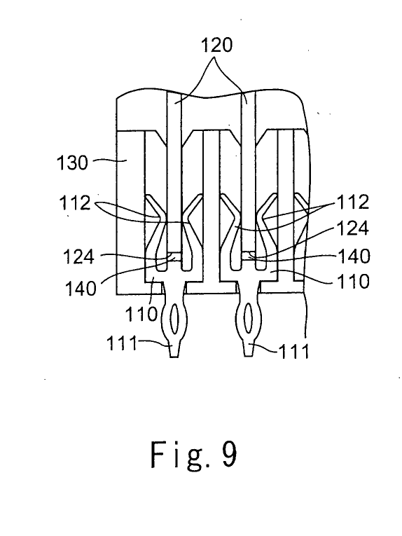

FIG. 8 is a diagram showing a substrate in a connector according to a second embodiment of the present invention and FIG. 9 is a schematic diagram showing an enlarged view of terminals of the connector according to the second embodiment of the present invention. FIGS. 8 and 9 correspond, respectively, to FIGS. 4 and 6 presented above in relation to the first embodiment. The same components as those in FIGS. 4 and 6 will be denoted by the same reference numerals as the corresponding components in FIGS. 4 and 6, and description thereof will be omitted.

According to the second embodiment, a thin insulating plate 140 is installed along the bottom edge 124 of the sub-board 120 as shown in FIG. 8 and the terminals 110 are connected to the sub-boards 120 with the insulating plate 140 sandwiched between the sub-boards 120 and terminals 110 as shown in FIG. 9. An insulator, which is harder than the insulator used as the base material of the sub-boards 120, is used for the insulating plate 140. By sandwiching the insulating plates 140 between the bottom edge 124 of the sub-boards 120 and the sub-board supports 113 of the terminals 110 (see FIG. 7), it is possible to more reliably prevent the bottom edges 124 of the sub-boards 120 from buckling when the compliant sections 111 of the terminals 110 are inserted into the through-holes in the main board.

What is claimed is:

1. An electrical connector, comprising:
a plurality of terminals equipped with compliant sections to be inserted into through-holes in a main board;
a plurality of sub-boards equipped with lands connected to the terminals and a contact section to be connected to a mating connector, where the lands consist of a conductor formed on an insulator;
a housing used to secure the plurality of sub-boards in an array,
whereby the lands extend close to a terminal-side edge of the insulator to prevent the sub-boards from buckling when the compliant sections are inserted into the through-holes in the main board.

2. An electrical connector, comprising:
a plurality of terminals equipped with compliant sections to be inserted into through-holes in a main board;
a plurality of sub-boards equipped with lands connected to the terminals and a contact section to be connected to a mating connector, where the lands consist of a conductor formed on an insulator; and
a housing used to secure the plurality of sub-boards in an array,
wherein the lands extend close to a terminal-side edge of the insulator to serve as stopping means which stop displacement of the terminals when the compliant sections are inserted into the through-holes in the main board.

3. An electrical connector, comprising:
a plurality of terminals equipped with compliant sections to be inserted into through-holes in a main board;
a plurality of sub-boards equipped with lands connected to the terminals and a contact section to be connected to a mating connector, where the lands consist of a conductor formed on an insulator; and
a housing used to secure the plurality of sub-boards in an array,
wherein the conductor extends close to a terminal-side edge of the insulator, such that the lands serve as prevention means which prevents progress of buckling of the sub-boards bitten by the terminals when the compliant sections are inserted into the through-holes in the main board.

4. The electrical connector, according to claim 1, wherein a part of each land which is close to the edge is narrower than the remainder of the land.

5. The electrical connector, according to claim 2, wherein a part of each land which is close to the edge is narrower than the remainder of the land.

6. The electrical connector, according to claim 3, wherein a part of each land which is close to the edge is narrower than the remainder of the land.

7. The electrical connector, according to claim 1, wherein an insulator being harder than the insulator forming the sub-boards is placed between the terminals and the sub-boards.

8. The electrical connector, according to claim 2, wherein an insulator being harder than the insulator forming the sub-boards is placed between the terminals and the sub-boards.

9. The electrical connector, according to claim 3, wherein an insulator being harder than the insulator forming the sub-boards is placed between the terminals and the sub-boards.

10. The electrical connector, according to claim 4, wherein an insulator being harder than the insulator forming the sub-boards is placed between the terminals and the sub-boards.
